(19) United States
(12) Patent Application Publication
(10) Pub. No.: US 2014/0149037 A1
(43) Pub. Date: May 29, 2014

(54) METHOD AND SYSTEM FOR SURVEYING A DISTRIBUTION OF CHARGEABILITY IN A VOLUME OF EARTH

(71) Applicants: Eldad Haber, Vancouver (CA); David William Frederick Marchant, Vancouver (CA); Douglas W. Oldenburg, Vancouver (CA)

(72) Inventors: Eldad Haber, Vancouver (CA); David William Frederick Marchant, Vancouver (CA); Douglas W. Oldenburg, Vancouver (CA)

(21) Appl. No.: 14/088,130

(22) Filed: Nov. 22, 2013

Related U.S. Application Data
(60) Provisional application No. 61/730,915, filed on Nov. 28, 2012.

(51) Int. Cl. G01V 3/08

(52) U.S. Cl. CPC G01V 3/087
USPC 702/2

(57) ABSTRACT

A method for surveying a distribution of chargeability in a volume of earth includes inducing polarization in the volume of earth by applying first and second primary magnetic fields to the volume of earth, with the first and second primary magnetic fields respectively oscillating at a first and second frequencies. First and second secondary magnetic fields emitted by the volume of earth in response to application of the primary magnetic fields are measured, with the first and second frequencies being selected such that the induction number of the volume of earth is less than unity, and, in one example, such that the imaginary portions of the secondary magnetic fields depend approximately linearly upon frequency. Distribution of chargeability can be determined for the volume of earth from a linear combination of the first and second secondary magnetic fields.

### CROSS-REFERENCE TO RELATED APPLICATION

Pursuant to 35 U.S.C. §119(e), this application claims the benefit of provisional U.S. Patent Application No. 61/730,915, filed Nov. 28, 2012 and entitled “Method and System for Surveying a Distribution of Chargeability in a Volume of Earth,” which is hereby incorporated by reference in its entirety.

### TECHNICAL FIELD

The present disclosure is directed at methods, systems, and techniques for surveying a distribution of chargeability in a volume of earth.

### BACKGROUND

Induced polarization surveys are commonly performed to map the distribution of electrical chargeability that is a diagnostic physical property in mineral exploration and in many environmental problems. While these surveys have been successful in the past, the galvanic sources required for traditional induced polarization surveys and for magnetic induced polarization surveys prevent them from being applied in some geological settings. Research and development accordingly continue into methods, systems, and techniques for expanding the versatility and usefulness of these and other types of surveys.

### SUMMARY

According to a first aspect, there is provided a method for surveying a distribution of chargeability in a volume of earth. The method comprises inducing polarization in the volume of earth by applying first and second primary magnetic fields to the volume of earth, wherein the first primary magnetic field oscillates at a first frequency and the second primary magnetic field oscillates at a second frequency different from the first frequency; measuring first and second secondary magnetic fields emitted by the volume of earth in response to application of the first and second primary magnetic fields, wherein the first and second frequencies are selected such that an induction number for the volume of earth is less than unity; and determining the distribution of chargeability for the volume of earth from a linear combination of imaginary components of the first and second secondary magnetic fields.

The first and second frequencies may be selected such that imaginary portions of the secondary magnetic fields depend approximately linearly upon frequency.

The linear combination may comprise a scaled linear combination of the imaginary components of the secondary magnetic fields, a scaled linear combination of the real and imaginary components of the secondary magnetic fields, an absolute value of a scaled linear combination of the imaginary components of the secondary magnetic fields, an absolute value of a scaled linear combination of the real and imaginary components of the secondary magnetic fields, a scaled linear combination of absolute values of the imaginary components of the secondary magnetic fields, or a scaled linear combination of absolute values of the real and imaginary components of the secondary magnetic fields.

The primary magnetic fields may be applied from a ground based transmitter, the secondary magnetic fields may be measured from a ground based receiver, and the linear combination may comprise

$$Im ( {H}^{s} ( {ω}_{2} ) ) - \frac{{ω}_{2}}{{ω}_{1}} Im ( {H}^{s} ( {ω}_{1} ) ) ,$$

wherein ω₁ is the first frequency, ω₂ is the second frequency, H^{s}(ω₁) is the first secondary magnetic field, and H^{s}(ω₂) is the second secondary magnetic field.

The primary magnetic fields may be applied from a ground based transmitter, the secondary magnetic fields may be measured from a ground based receiver, and the linear combination may comprise

$$Im ( {H}^{s} ( {ω}_{2} ) ) + Re ( {H}^{s} ( {ω}_{2} ) ) - \frac{{ω}_{2}}{{ω}_{1}} [ Im ( {H}^{s} ( {ω}_{1} ) ) + Re ( {H}^{s} ( {ω}_{1} ) ) ] ,$$

wherein ω₁ is the first frequency, ω₂ is the second frequency, H^{s}(ω₁) is the first secondary magnetic field, and H^{s}(ω₂) is the second secondary magnetic field.

The primary magnetic fields may be applied from an air based transmitter, the secondary magnetic fields may be simultaneously measured using an air based receiver, and the linear combination may comprise

$$\vert Im ( {H}^{s} ( {ω}_{2} ) ) - \frac{{ω}_{2}}{{ω}_{1}} Im ( {H}^{s} ( {ω}_{1} ) ) \vert ,$$

wherein ω₁ is the first frequency, ω₂ is the second frequency, H^{s}(ω₁) is the first secondary magnetic field, and H^{s}(ω₂) is the second secondary magnetic field.

The primary magnetic fields may be applied from an air based transmitter, the secondary magnetic fields may be measured using an air based receiver, and the linear combination may comprise

$$\vert Im ( {H}^{s} ( {ω}_{2} ) ) \vert - \frac{{ω}_{2}}{{ω}_{1}} \vert Im ( {H}^{s} ( {ω}_{1} ) ) \vert ,$$

wherein ω₁ is the first frequency, ω₂ is the second frequency, H^{s}(ω₁) is the first secondary magnetic field, and H^{s}(ω₂) is the second secondary magnetic field.

The primary magnetic fields may be applied from an air based transmitter, the secondary magnetic fields may be measured using an air based receiver, and the linear combination may comprise

$$\vert Im ( {H}^{s} ( {ω}_{2} ) ) + Re ( {H}^{s} ( {ω}_{2} ) ) \vert - \frac{{ω}_{2}}{{ω}_{1}} \vert Im ( {H}^{s} ( {ω}_{1} ) ) + Re ( {H}^{s} ( {ω}_{1} ) ) \vert ,$$

wherein ω₁ is the first frequency, ω₂ is the second frequency, H^{s}(ω₁) is the first secondary magnetic field, and H^{s}(ω₂) is the second secondary magnetic field.

The primary magnetic fields may be applied from an air based transmitter, the secondary magnetic fields may be simultaneously measured using an air based receiver, and the linear combination may comprise

$$\vert Im ( {H}^{s} ( {ω}_{2} ) ) + Re ( {H}^{s} ( {ω}_{2} ) ) - \frac{{ω}_{2}}{{ω}_{1}} [ Im ( {H}^{s} ( {ω}_{1} ) ) + Re ( {H}^{s} ( {ω}_{1} ) ) ] \vert ,$$

wherein ω₁ is the first frequency, ω₂ is the second frequency, H^{s}(ω₁) is the first secondary magnetic field, and H^{s}(ω₂) is the second secondary magnetic field.

The secondary magnetic fields may be measured at different times.

The primary frequencies may be selected such that a depth of the volume of earth to be surveyed is within two skin depths of the higher of the primary frequencies. Alternatively, the primary frequencies may be selected such that a depth of the volume of earth to be surveyed is within one skin depth of the higher of the primary frequencies.

The primary frequencies may be within 5% of each other.

The primary frequencies may be 1 Hz and 2 Hz.

The higher of the primary frequencies may be less than or equal to approximately 45 Hz, or less than or equal to approximately 25 Hz.

The method may further comprise displaying a graph of the distribution of chargeability.

The method may further comprise compensating for motion while measuring the secondary magnetic fields by deblurring the graph.

According to another aspect, there is provided a method for surveying a distribution of chargeability in a volume of earth, the method comprising inducing polarization in the volume of earth by applying first and second primary magnetic fields to the volume of earth, wherein the first primary magnetic field oscillates at a first frequency and the second primary magnetic field oscillates at a second frequency different from the first frequency; measuring first and second secondary magnetic fields emitted by the volume of earth in response to application of the first and second primary magnetic fields, wherein the first and second frequencies are selected such that actual values of imaginary portions of the secondary magnetic fields are within 20% of values of the imaginary portions determined assuming the imaginary portions depend linearly upon frequency; and determining the distribution of chargeability for the volume of earth from a linear combination of the first and second secondary magnetic fields.

According to another aspect, there is provided a system for surveying distribution of chargeability in a volume of earth, the system comprising a magnetic transmitter; a magnetic receiver; a processor; and a memory having encoded thereon statements and instructions to cause the processor to perform any of the foregoing methods.

According to another aspect, there is provided a system for surveying distribution of chargeability in a volume of earth, the system comprising a magnetic transmitter configured to generate a first primary magnetic field oscillating at a first frequency and a second primary magnetic field oscillating at a second frequency different from the first frequency; a magnetic receiver configured to measure first and second secondary magnetic fields emitted by the volume of earth in response to application of the first and second primary magnetic fields, wherein the first and second frequencies are selected such that an induction number for the volume of earth is less than unity; a processor; and a memory having encoded thereon statements and instructions to cause the processor to determine the distribution of chargeability for the volume of earth from a linear combination of imaginary components of the first and second secondary magnetic fields.

According to another aspect, there is provided a non-transitory computer readable medium having encoded thereon statements and instructions to cause a processor to perform any of the foregoing methods.

According to another aspect, there is provided a non-transitory computer readable medium having encoded thereon statements and instructions to cause a processor to determine a distribution of chargeability for a volume of earth from a linear combination of imaginary components of first and second secondary magnetic fields generated by applying first and second primary magnetic fields to the volume of earth, wherein the first primary magnetic field oscillates at a first frequency and the second primary magnetic field oscillates at a second frequency different from the first frequency, and wherein the first and second frequencies are selected such that an induction number for the volume of earth is less than unity.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts the geometry of a two block model representative of a volume of earth to which a method for surveying a distribution of chargeability, according to one embodiment, is applied.

FIG. 2 depicts distributions of chargeability of the volume of earth of FIG. 1 generated according to the method of FIG. 1, and compares these distributions to graphs of magnetic fields of the volume of earth of FIG. 1.

FIG. 3 depicts a real part of a complex three dimensional resistivity model of another volume of earth to which the method of FIG. 1 is applied.

FIG. 4 depicts distributions of chargeability of the volume of earth of FIG. 3 generated according to the method of FIG. 1, and compares these distributions to graphs of magnetic fields of the volume of earth of FIG. 3.

FIG. 5 depicts distributions of chargeability of the volume of earth of FIG. 3 obtained using different transmitter currents.

FIG. 6 depicts distributions of chargeability of the volume of earth of FIG. 3 obtained at various frequencies.

FIGS. 7, 8, and 10 depict true and recovered δρRₑ, according to another embodiment.

FIG. 9 depict true and recovered resistivity models, according to another embodiment.

FIGS. 11 and 12 depict a system for surveying a distribution of chargeability in a volume of earth, according to another embodiment.

FIG. 13 depicts a flowchart of a method for surveying a distribution of chargeability in a volume of earth, according to another embodiment.

FIGS. 14 and 15 depict ISIP data determined at various frequencies, according to two different embodiments.

### DETAILED DESCRIPTION

Directional terms such as “top,” “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment.

The presence of polarizable material in the ground is an excellent proxy for the distribution of metallic minerals and hence induced polarization (“IP”) surveys are routinely used for mineral exploration. Recent studies have also applied the observation of IP effects to hydrocarbon exploration, hydrogeologic mapping, and numerous other environmental and engineering applications. The causes of electric polarization, or equivalently chargeability, are varied, but regardless of the cause a chargeable material will have a complex, frequency dependent conductivity.

Traditionally, measurements of chargeability are carried out using the IP technique. This purely galvanic technique injects current into the ground through a pair of transmitter electrodes and then measures the voltage decay across another set of electrodes after the current has been interrupted. The method has a proven track record in mineral exploration and is widely considered the geophysical method of choice when looking for porphyry copper deposits. These data may be inverted to recover 2D or 3D models of the chargeability distribution in the ground.

Despite IP's success, its application is not always practical. The time and cost required to survey large areas can often be prohibitively large. Some geologic settings can also cause traditional IP to fail. For example, IP struggles in regions where highly conductive or highly resistive overburden exists. In areas of high conductivity, the overburden essentially short-circuits the electrode pairs. When high resistivity is present it becomes difficult to inject enough current into the ground to excite the polarizable body.

An alternative method for mapping chargeability that addresses some of these shortcomings is referred to as magnetic induced polarization (“MIP”). In MIP, current is again injected into the ground across two transmit electrodes, but observations of the secondary magnetic field are used rather than electrical potentials. This eliminates the time consuming requirement of placing receiver electrodes, and provides improved performance when operating where highly conductive overburden exists.

The MIP method requires that current be injected into the ground and thus it still suffers in areas covered by highly resistive overburdens. To overcome this challenge, the embodiments described herein use an inductive method. Disclosed is a new data collection, processing and inversion methodology to map the distribution of chargeability using inductive sources and observations of magnetic fields in the frequency domain. The asymptotic behaviour of the magnetic fields at low frequencies is exploited to identify the presence of an IP response, and an inversion scheme to recover the three dimensional distribution of chargeability is developed.

In the discussion that follows, magnetic fields H are applied to a volume of earth when surveying a distribution of chargeability. Two magnetic fields are applied to the volume of earth at first and second frequencies, with the second frequency being different from the first frequency; these applied magnetic fields are “primary magnetic fields”. In assessing chargeability, the magnetic fields induced in the volume of earth by these primary magnetic fields are measured, and what are referred to as ISIP data, below, are measured. These induced magnetic fields from which the ISIP data are determined are “secondary magnetic fields”.

### A Model for Inductive Source IP

In this section, the behaviour of Maxwell's equations at low frequency is examined. In particular, how the presence of a chargeable material affects the resulting secondary magnetic fields is examined.

Maxwell's equations in the frequency domain are

∇×E−iωμH=0 (1)

∇×H−σE=s (2)

Here E and H are the electric and magnetic fields, σ is the conductivity and μ the magnetic susceptibility. H is defined such that H=H₀+H^{s} and ∇×H₀=s. Here, H₀ is the magnetic field generated by a current loop at zero frequency, which can be calculated using the Biot-Savart law. Equation 1 can be rewritten in terms of H^{s} as

∇×E−iωμH^{s}=iωμH₀ (3)

∇×H^{s}−σE=0 (4)

Eliminating E from the system yields an equation for H^{s}

∇×ρ∇×H^{s}−iωμH^{s}=iωμH₀ (5)

where ρ is the resistivity,

$$ρ = \frac{1}{σ} .$$

This equation represents the forward problem for magnetic fields arising from an inductive source.

Now, assume a frequency-independent (non-chargeable) resistivity distribution ρ. The derivatives of H^{s} with respect to ω can be determined by differentiating Equation 5. The following results after differentiating:

$$∇ \times ρ ∇ \times \frac{\partial {H}^{s}}{\partial ω} - iωμ \frac{\partial {H}^{s}}{\partial ω} = iμ ( {H}_{0} + {H}^{s} )$$

Equation 6 is a partial differential equation for

$$\frac{\partial {H}^{s}}{\partial ω} .$$

It has the same form as the system for H^{s} but a different right hand side. From Equation 6, it is seen that as ω→0 the derivative

$$\frac{\partial {H}^{s}}{\partial ω}$$

becomes is purely imaginary, giving

$$\begin{matrix}Im ( {H}^{s} ( ω , ρ ) ) \approx \frac{\partial {H}^{s}}{\partial ω} {\vert}_{ω = 0} ω \\ or & ( 7 ) \\ \frac{Im ( {H}^{s} ( ω , ρ ) )}{ω} \approx \frac{\partial {H}^{s}}{\partial ω} {\vert}_{ω = 0} \approx const . & ( 8 )\end{matrix}$$

### Inductive Source IP

The foregoing shows that the behaviour of the imaginary part of the secondary magnetic field can be predicted at low frequencies when no chargeable material is present. This property can be used to detect chargeability.

Consider the magnetic response of a non-chargeable volume of earth to forcing from an inductive source operating at two closely spaced, low frequencies ω₁ and ω₂. If the frequencies are sufficiently low then the skin-depth is very large compared to the geometric decay of the source fields and the measured response is sensitive to the same volume of earth. From Equation 8:

$$\frac{Im ( {H}^{s} ( {ω}_{2} ) )}{{ω}_{2}} - \frac{Im ( {H}^{s} ( {ω}_{1} ) )}{{ω}_{1}} \approx 0 \qquad ( 9 )$$

This observation provides motivation to introduce a new quantity d^{ISIP}, defined as the Inductive Source IP (ISIP) data, d^{ISIP}:

$${d}^{ISIP} = Im ( {H}^{s} ( {ω}_{2} ) ) - \frac{{ω}_{2}}{{ω}_{1}} Im ( {H}^{s} ( {ω}_{1} ) ) \qquad ( 10 )$$

A datum is obtained by taking a scaled linear combination of two recorded magnetic fields, thus the ISIP data are secondary signals that are directly related to the chargeable earth. For any real, non-dispersive resistivity distribution the ISIP data, d^{ISIP}, should approximately equal zero. Non-zero values indicate the presence of chargeable material. In Equation 10, the scaled linear combination excludes combining real components of the first and second secondary magnetic fields and, in particular, involves determining a difference between imaginary components of the secondary magnetic fields. As demonstrated by Equation 10, a scaled linear combination includes a combination in which any one or more terms is linearly scaled.

The effectiveness of the ISIP data in recovering chargeable targets is demonstrated below using examples.

### SYNTHETIC EXAMPLE #1

### Two Blocks in a Half-Space

The sensitivity of the ISIP data to chargeable material is tested using two synthetic examples. The first test involves two conductive blocks 102,104 in a volume of earth in the form of a resistive half-space. Both blocks 102,104 have a resistivity of 1 Ωm and the half-space has resistivity of 1000 Ωm. One of the blocks 102 is chargeable. In the second test the same two blocks 102,104 are used but embedded them in a more complicated geologic background.

The frequency dependence of a material's resistivity is commonly parameterized by the Cole-Cole model:

$$ρ ( ω ) = {ρ}_{0} ( 1 - η ( 1 - \frac{1}{1 + {( iωπ )}^{c}} ) ) \qquad ( 11 )$$

where ρ₀ (Ωm) is the resistivity at zero frequency, η is the chargeability, τ (seconds) is a time constant, and c is the frequency dependence. In this example, the chargeable block 102 is modelled with Cole-Cole parameters η=0.1, τ=0.1 and c=0.5. The tops of the blocks 102,104 are buried 125m below the surface of the halfspace. There is a single transmitter 106 that is offset from the two conductive blocks 102,104 and the magnetic fields are simulated at 1 Hz and 2 Hz. These parameters result in a change between the two frequencies of 1.0×10⁻² Ωm in the real part and 2.4×10⁻⁴ Ωm in the imaginary part of the resistivity of the chargeable block 102.

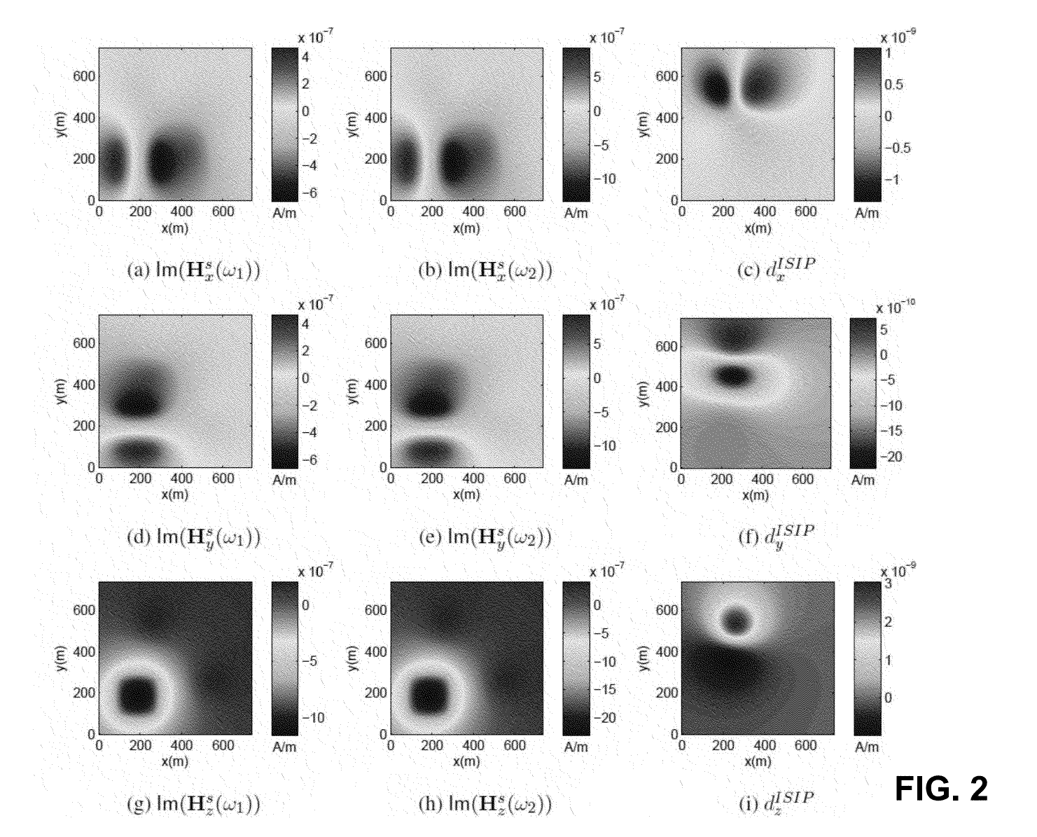

The resulting secondary magnetic fields, and the calculated ISIP data are shown in FIG. 2. The secondary magnetic fields at the two frequencies are similar in form but have different amplitudes. It is difficult to determine the presence of the blocks 102,104 from the appearance of the secondary magnetic fields, let alone determine whether either of them are chargeable. Equation 10 was used to calculate the ISIP data from these magnetic fields. The [SIP data are shown in the third column in FIG. 2. The existence and approximate location of the chargeable block 102 is easily determined from looking at the ISIP data of FIG. 2.

### SYNTHETIC EXAMPLE #2

### Two Blocks in a Complex Background

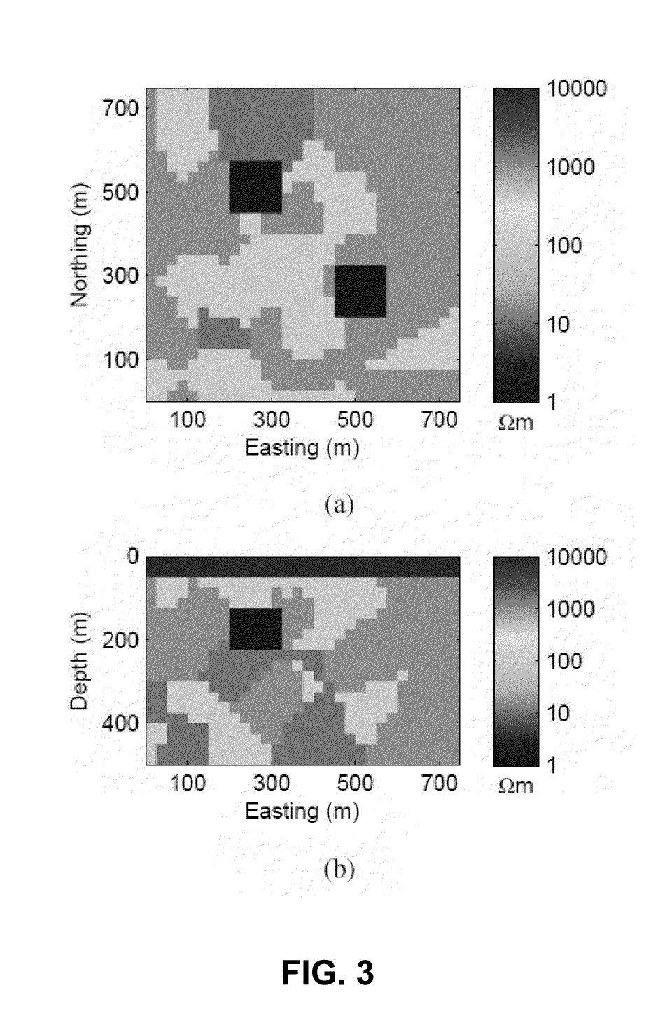

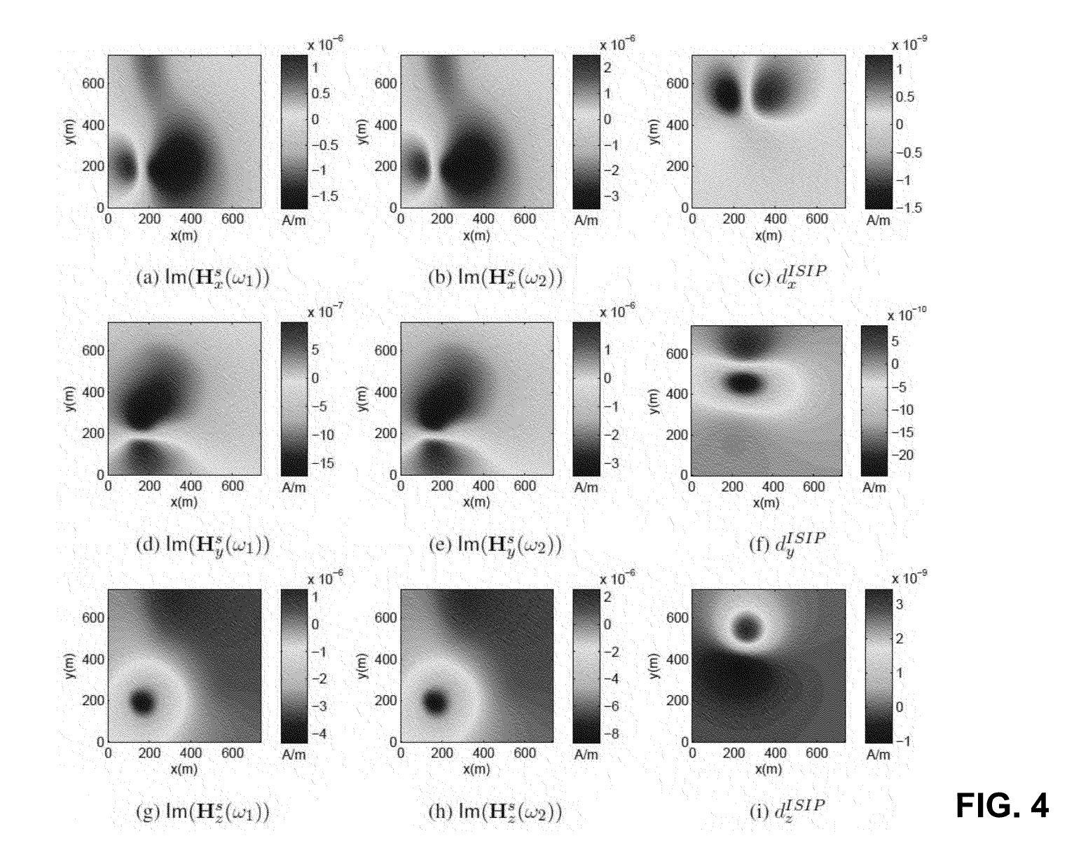

In the second synthetic example the same two blocks 102,104 are placed in a volume of earth in the form of a complicated 3-D background, and buried beneath a very resistive overburden. The resistivity of the background units vary between 10 Ωm and 1000 Ωm. The overburden has a resistivity of 10000 Ωm. Cross sections through this model are shown in FIG. 3. The resulting secondary magnetic fields, and the calculated ISIP data are shown in FIG. 4. The anomalous ISIP response from the chargeable block is clearly evident and it is very similar to that of the previous example despite the fact that the chargeable body is buried in a host with a very different conductivity structure.

### Sources of Error

The results in the last section showed that ISIP data can be a direct indicator of polarizable material. To be useful in field situations, the ISIP signal must be larger than the “noise”. There are two factors to be considered. The first is the intrinsic noise of the instrument used for measurements; the second is the “noise” inherent in the analysis procedure when the low frequency assumption is violated. Each of these is considered in turn, below.

### Noisy Magnetic Fields and Error Propagation

An ISIP datum is a linear combination of two measured data and hence its variance is determined by the accuracy of each measurement. If it is assumed that the observations of Im(H^{s}(ω₁)) have a variance of σₕ_{₁}, that Im(H^{s}(ω₂)) has a variance of σₕ_{₂}, and that errors are uncorrelated then the variance in the resulting ISIP data is

$${σ}_{ISIP} = \sqrt{{σ}_{{h}_{2}}^{2} + {( \frac{{ω}_{2}}{{ω}_{1}} {σ}_{{h}_{1}} )}^{2}} \qquad ( 12 )$$

In the case where σₕ_{₁}=σₕ_{₂}=σₕ this simplifies to

$${σ}_{ISIP} = \sqrt{1 + {( \frac{{ω}_{2}}{{ω}_{1}} )}^{2}} {σ}_{h} \qquad ( 13 )$$

Thus, the variance in the ISIP data is larger than the variance in the measurements of the magnetic fields used to calculate the ISIP response. While the magnitude of the variance only slightly increases for closely spaced frequencies, the magnitude of the ISIP data is significantly less than the magnitude of the original, primary magnetic fields as a result of Equation 10. This results in an increase in the relative variance of the ISIP data compared to the relative variance in the original, primary magnetic fields.

Using modern SQUID magnetometers, resolutions of 20 fT(1.6×10⁻⁸ A/m) have been achieved at 1 Hz. If instrumentation noise is 20 fT/√(Hz) and frequencies of 1 and 2 Hz are used, then σ_{ISIP}=4.3×10⁻⁸ A/m.

The magnitude of the ISIP signal is controlled by many factors. Principally however, it depends upon the size and geometry of the target and its location relative to the transmitter 106, the geometry of the transmitter and the magnitude of the current, the Cole-Cole (or other complex conductivity description of the target material) and the choice of frequencies. The relationship between most of these parameters and the ISIP data is complicated. The exception is transmitter current; the ISIP data depend linearly on the magnitude of the current.

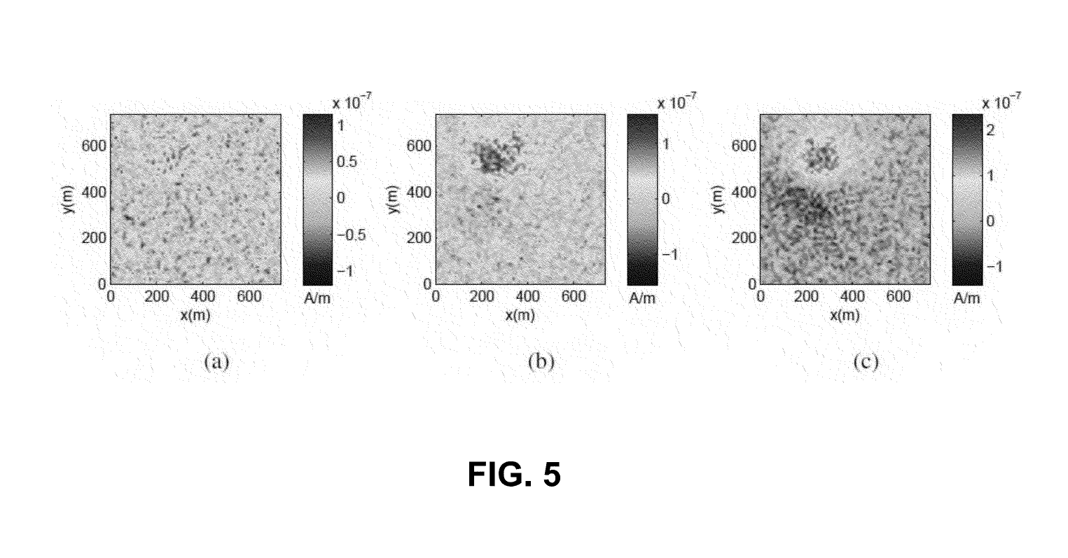

To illustrate the fact that ISIP data can be large enough to be recorded with current instruments, it is noted that in the example of FIG. 4, for a 1 A current the maximum ISIP signal in FIG. 4 occurs in the z-component and is 0.35×10⁻⁸ A/m. The estimated standard deviation for this datum is σ_{ISIP}=4.3×10⁻⁸ A/m. FIG. 5 shows the noisy ISIP that would be measured when the transmitter current is respectively 1 A (FIG. 5(a)), 10 A (FIG. 5(b)), and 50 A (FIG. 5(c)). EM transmitters capable of producing currents up to 50 A are commercially available. With a 50 A transmitter, and resolving power of 4.3×10⁻⁸ A/m the ISIP response is easily visible in the data (FIG. 5).

This is just an example and it does not represent the best case scenario. Different transmitter and receiver geometries, a shallower target, or a different Cole-Cole model could achieve a higher magnitude response.

### Low Frequency Assumption

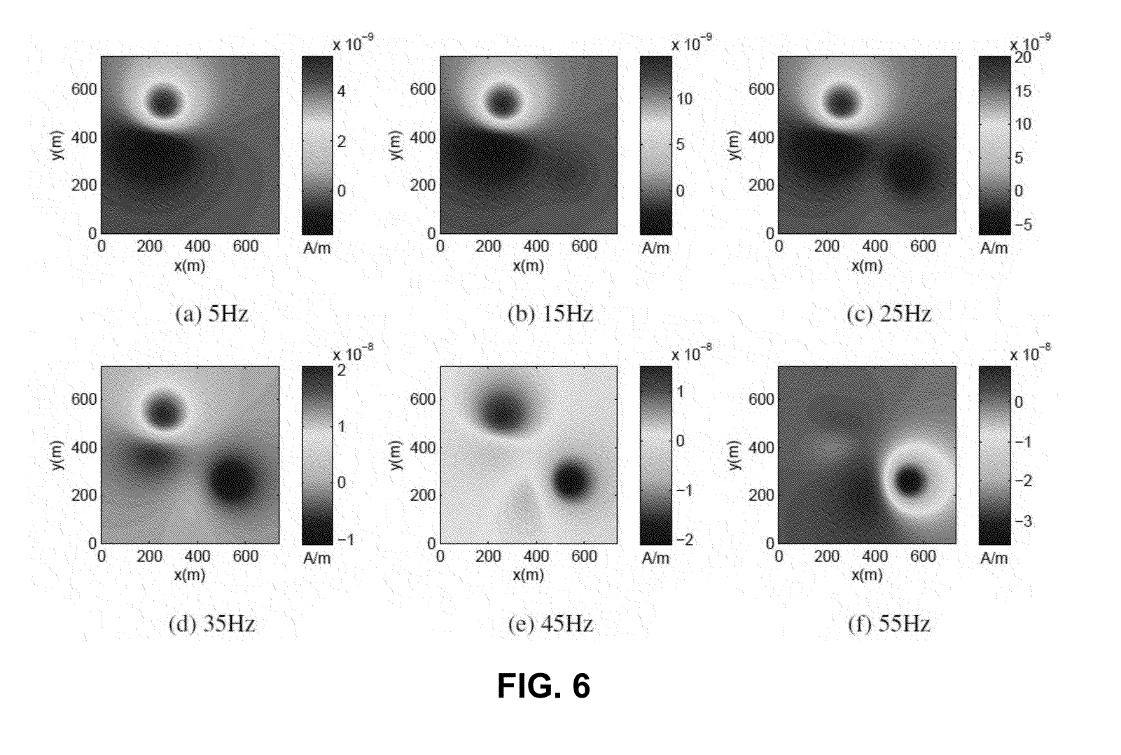

The second area in which “noise” can contaminate the analysis occurs if the low frequency assumptions are violated. Low frequencies are used in this derivation for two reasons. First, while deriving the expressions for the ISIP data, it is assumed that observations of the magnetic fields are made at sufficiently low frequencies that the higher order terms of the expansion of Equation 5 can be dropped. The imaginary portion of the secondary magnetic field, which is recorded, then depends approximately linearly upon frequency. The value of the induction number is the determining factor in the validity of this assumption. As long as the induction number is much less than unity, the ISIP data will be equal to zero unless chargeable material is present. As the value of the induction number increases, however, additional sources of signal become apparent in the data. Also, as induction number increases so that the linear dependence on frequency begins to be violated, it may be necessary to restrict the difference between the two frequencies that are used to compute the ISIP data. However, reducing the difference between the two frequencies will also reduce the magnitude of the ISIP signal. Nonetheless, the nonlinearity due to inductive effects is not so large that it prevents quality ISIP data from being recorded at relatively high frequencies. Returning to the ISIP data for the simple two block model used in the first example, except computing data using frequencies from 5-55 Hz results in the resultant data shown in FIG. 6. ISIP data require measurements of magnetic field at two frequencies. The lower of the two frequencies used are shown in the figure. The higher frequency is 5% larger. In each case, the Cole-Cole model is slightly modified to ensure that the difference in resistivity between the two frequencies remains constant. At low frequencies, the ISIP data are a dipolar response centred over the chargeable block. As the frequencies increase, non-zero signals begin to appear in the ISIP data away from the chargeable block. At these frequencies, starting around 25 Hz, the magnetic fields no longer vary linearly with frequency.

In the depicted embodiments, the induction number of the volume of earth can be approximated using the following:

$$α \approx {r ( \frac{σμω}{2} )}^{1 / 2} \qquad ( 13.5 )$$

where α is the induction number, ω is the angular frequency of the primary magnetic field, μ is the average magnetic permeability of the volume of earth, σ is an average background value for near surface conductivity, and r is a length scale such as the transmitter-receiver offset. Beneficially and as mentioned above, when the induction number is much less than 1 (e.g.: ˜0.1 or lower), the imaginary portion of the secondary magnetic field depends approximately linearly upon frequency, which facilitates relatively accurate surveying.

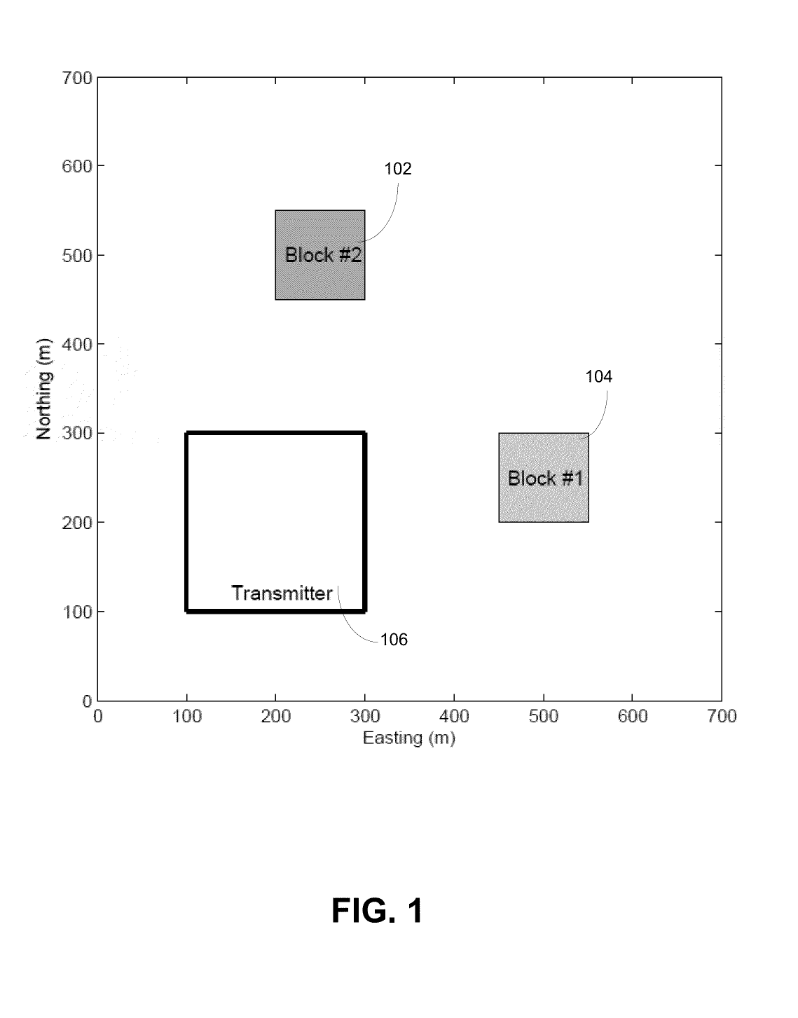

In alternative embodiments, the requirement of linear dependence of the secondary magnetic fields on frequency may be relaxed at the cost of accuracy in distinguishing between chargeable and non-chargeable media. For example, as shown in FIG. 6, the ISIP data still identifies the chargeable block 102 of FIG. 1 as being more chargeable than the other block 104 at 45 Hz, notwithstanding that the magnetic fields no longer vary linearly with frequency starting at approximately 25 Hz. As another example, in one such alternative embodiment, surveying may be done so long as the induction number is less than unity, with accuracy decreasing as the induction number approaches unity. As another example, surveying may be done when the frequencies are selected such that actual values of imaginary portions of the secondary magnetic fields are within 20% of values of the imaginary portions determined assuming the imaginary portions depend linearly upon frequency. By “within 20%”, it is meant any range of percentages selected from 0% to 20%, inclusively.

### Discretization of the ISIP Forward Modeling

In this section is discussed how to obtain a discrete systems of equations for the ISIP data. Since the ISIP data are derived from the magnetic field the discretization of Maxwell's equations is also briefly discussed. The problem is then linearized in order to obtain a discrete linear inverse problem for the distribution of chargeable material given the ISIP data.

### Discretization of Maxwell's Equations

Consider the system for H^{s} given ρ (Equation 5). The system has a nontrivial null space (the gradient of scalar functions) when ω→0 and therefore is to be stabilized. To stabilize the system at very low frequency the source condition ∇μH^{s}=0 is used and, assuming μ is constant, ∇ρ∇·H^{s} is added to Equation 5 to obtain

∇×ρ∇×H^{s}−∇ρ∇·H^{s}−iωμH^{s}=iωμH₀ (14)

This allows for a solution of the system even for ω=0. For boundary conditions n×H^{s}=0 is used. For numerical evaluation, the system is discretized on an orthogonal, staggered grid and a finite volume approach with material averaging of resistivitiesis used.

H^{s} is placed on cell edges and ρ is defined at the cell centers. The discrete equation is

(curl^{T}diag(A_{c}^{e}ρ)curl+graddiag(A_{c}ⁿρ)grad^{T}−iωμI)H^{s}=iωμH₀ (15)

where curl and grad are discrete forms of the curl and gradient operators, obtained by short differences on staggered grids and A_{c}^{e} and A_{c}ⁿ are averaging matrices from cell to edges and nodes respectively. The system is solved for H^{s} using a direct solver.

### Linearization of Inductive Source IP Equations

In order to invert for chargeable material the ISIP data is connected to changes in the resistivity with frequency. Since this change is small simple linearization is used.

Chargeability causes small perturbations in resistivity as a function of frequency. Let ρ₁ and ρ₂ be the resistivities that would be observed at frequencies ω₁ and ω₂. Since the frequencies ω₁ and ω₂ are closely spaced, the resistivity that would be observed at ω₂ is approximately equal to the resistivity at ω₁ plus a small perturbation, or ρ₂≈ρ₁+δρ. Expanding the magnetic field using the first order Taylor's expansion around ρ=ρ₁ results in Equation 16:

$${H}^{s} ( {ω}_{2} , {ρ}_{2} ) \approx {H}^{s} ( {ω}_{2} , {ρ}_{1} ) + \frac{\partial {H}^{s}}{\partial ρ} ( {ω}_{2} , {ρ}_{1} ) δρ \qquad ( 16 )$$

The complex sensitivity matrix J is defined to be

$$J = Q \frac{\partial {H}^{s}}{\partial ρ} ( {ω}_{2} , {ρ}_{1} ) \qquad ( 17 )$$

where Q is a projection matrix that projects the magnetic field H^{s} to the receiver locations. The (i, j) element of J contains how the i^{th} observation of H^{s} will be affected by a small perturbation in resistivity in the j^{th} cell. Using the result from Equation 8 allows Equation 18 to be derived:

$$Im ( {QH}^{s} ( {ω}_{2} , {ρ}_{1} ) ) \approx \frac{{ω}_{2}}{{ω}_{1}} Im ( {QH}^{s} ( {ω}_{1} , {ρ}_{1} ) ) \qquad ( 18 )$$

Combining this expression with Equation 16 yields

$$Im ( {QH}^{s} ( {ω}_{2} , {ρ}_{2} ) ) \approx \frac{{ω}_{2}}{{ω}_{1}} Im ( {QH}^{s} ( {ω}_{1} , {ρ}_{1} ) ) + Im ( J δρ ) \qquad ( 19 )$$

Then, using the definition of the ISIP data (Equation 10), projecting to the receiver locations, Equation 20 results:

d^{ISIP}=Im(Jδρ)=J_{Rc}δρ_{Im}+J_{Im}δρ_{Re}. (20)

where the notations (·)_{Re} and (·)_{Im} are used to denote the real and imaginary components of (·), respectively.

This is a coupled system for [δρ_{Re}, δρ_{Im}] given the ISIP data. Fortunately, the system can be decoupled when working at low frequencies. To see that, the sensitivity matrix obtained around a real resistivity value ρ and low frequency ω is analyzed.

Differentiating Equation 15 with respect to ρ results in

$$( {curl}^{T} diag ( {A}_{c}^{e} ρ ) curl + graddiag ( {A}_{c}^{n} ρ ) {grad}^{T} - iωμ I ) \frac{\partial {H}^{s}}{\partial ρ} + ( {curl}^{T} diag ( {curlH}^{s} ) {A}_{c}^{e} + graddiag ( {grad}^{T} {H}^{s} ) {A}_{c}^{n} ) = 0 \qquad ( 21 )$$

and therefore, the sensitivity matrix is

J=−(curl^{T}diag(A_{c}^{e}ρ)curl+graddiag(A_{c}ⁿρ)grad^{T}−iωμI)⁻¹(curl^{T}diag(curlH^{s})A_{c}^{e}+graddiag(grad^{T}H^{s})A_{c}ⁿ) (22)

The sensitivity matrix for low frequencies is now examined. The EM forward modeling matrix is

A(ρ)=curl^{T}diag(A_{c}^{e}ρ)curl+graddiag(A_{c}ⁿρ)grad^{T}−iωμI. (23)

The discretization of the differential terms are of order h⁻²ρ while the last term is of order ωμ where h is the length of one edge of the smallest cells in the mesh. If ω=h⁻²ρμ⁻¹ then the term involved with ω can be neglected, and therefore, for low frequencies A(ρ)≈A(ρ)_{Re}.

The second part in the sensitivity involves the differential operators and H^{s}. As seen previously, in Equation 7, H^{s} is dominated by its imaginary part at low frequencies. These two observations imply that |J_{Re}|=|J_{Im}|.

Using the asymptotic properties of J it is possible to simplify the system of Equation 20. As J_{Re} is very small, the term J_{Re}δρ_{Im} can be dropped from Equation 20 and the result is a linear relationship between the ISIP data and δρ_{Re}:

d^{ISIP}≈J_{Im}δρ_{Re} (24)

### Solving the Linear Inverse Problem

Recovering δρ_{Re} using the approximation in Equation 24 is a simple linear inverse problem that can be solved using various techniques. Prior to inverting the ISIP data for δρ_{Re}, J_{Re} is approximated based on estimates of ρ (the zero-frequency resistivity structure) and H^{s} (the secondary magnetic fields arising from ρ). The estimated resistivity could be obtained by performing a 3D inversion of data at one of the two frequencies, or it could be generated in some other way.

The ISIP data are sensitive to the change in resistivity between the two frequencies being used, and not to the chargeability parameter used in common dispersion models. The model that results from inverting ISIP data maps the distribution of material that exhibits a change in resistivity between the two frequencies used. In the simple case of materials exhibiting dispersion that can be represented by a Debye model (c=1 in Equation 11); this change is proportional to the chargeability, η. In materials with other frequency dependencies, the relationship is not so simple. The presence of a non-zero δρ_{Re} directly indicates a non-zero chargeability; however a zero δρ_{Re} does not necessarily imply that the material is not chargeable. It means that the dispersion of the material is such that there is no measurable δρ_{Re} between the frequencies used.

### Inversion Methodology

The solution to the inverse problem is the model m that solves the optimization problem:

min φ=φ_{d}(m)+βφₘ(m)s.t0≦m (25)

In this equation, φ_{d} is a measure of the data misfit, φₘ is a user defined model objective function and β is regularization or trade-off parameter. The sum of the squares is used to measure data misfit:

$$\begin{matrix}{φ}_{d} = {‖ {W}_{d} ( Gm - {d}^{obs} ) ‖}_{2}^{2} \\ = {\sum }_{i = 1}^{N} {( \frac{{d}_{i}^{pred} - {d}_{i}^{obs}}{{ɛ}_{i}} )}^{2}\end{matrix} \qquad ( 26 )$$

where N is the number of observed data, and W_{d} is a diagonal data weighting matrix which contains the reciprocal of the estimated uncertainty of each datum (εᵢ) on the main diagonal.

The model objective function, φₘ, is a measure of amount of structure in the model and, upon minimization, will generate a smooth model this is close to a reference model m_{ref}. φₘ is defined as

φₘ=αₛ∥Wₛ(m−m_{ref})∥₂²+αₓ∥Wₓ(m−m_{ref})∥₂²+α_{y}∥W_{y}(m−m_{ref})∥₂²+α_{z}∥W_{z}(m−m_{ref})∥₂² (27)

where, Wₛ is a diagonal matrix, and Wₓ, W_{y} and W_{z} are discrete approximations of the first derivative operator in the x, y and z directions respectively. The α's are weighting parameters that balance the relative importance of producing small or smooth models.

The ISIP data equations are linear but the inverse problem is nonlinear because bound constraints on m are imposed to ensure reasonable valued results. The constrained optimization problem is solved using the Projected Newton method detailed in Kelley, C. T., 1999. Iterative methods for optimization, no. 18, SIAM Frontiers in Applied Mathematics. At the (n+1)^{th} iteration, this method requires the solution to

Rδm=−G^{T}W_{d}^{T}W_{d}(d^{obs}−dⁿ)−βW^{T}W(mⁿ−m_{ref}) (28)

where mⁿ is model produced at the n^{th} iteration, dⁿ are the data predicted by mⁿ, W is the regularization matrix and R is the reduced Hessian.

Equation 28 is solved using a preconditioned conjugate gradient method. This approach allows δm to be obtained with only the multiplication of R onto a vector. Once the search direction δm has been identified, the new model is given by mⁿ⁺¹=Proj(mⁿ+γδm), where γ (0<γ≦1) is chosen by a simple backtracking line search such that mⁿ⁺¹ reduces the objective function. Proj is a projection operator that projects the updated model back to feasible model space.

The regularization parameter is chosen using a cooling schedule. β is initially chosen to be very large so that βφₘ dominates the objective function. When the m that minimizes Equation 25 is identified, β is decreased by a constant factor. This continues until the desired level of data misfit is achieved.

### Inversion of Synthetic ISIP Data

The response of the model shown in FIG. 3 was calculated for a survey consisting of 25 transmitters laid out in a 5 by 5 grid. Each transmitter was a square loop, 200 m on a side. 169 receivers (13 by 13 grid) recorded the three components of the magnetic fields at 1 Hz and 2 Hz. The survey was simulated by solving Equation 15 at each of the two frequencies. The resulting data were then contaminated with random Gaussian noise with a standard deviation of 5.3×10⁻¹⁰ A/m (the noise level you could expect from a receiver with 1.6×10⁻⁸ A/m resolution while transmitting 30 A). Three components of ISIP data were then calculated from the simulated noisy magnetic fields using Equation 10. This resulted in 12675 unique data. Non-chargeable half-spaces were used for both the initial and reference models in the subsequent inversions. In this example, the real part of the true background resistivity model was used when calculating the sensitivities.

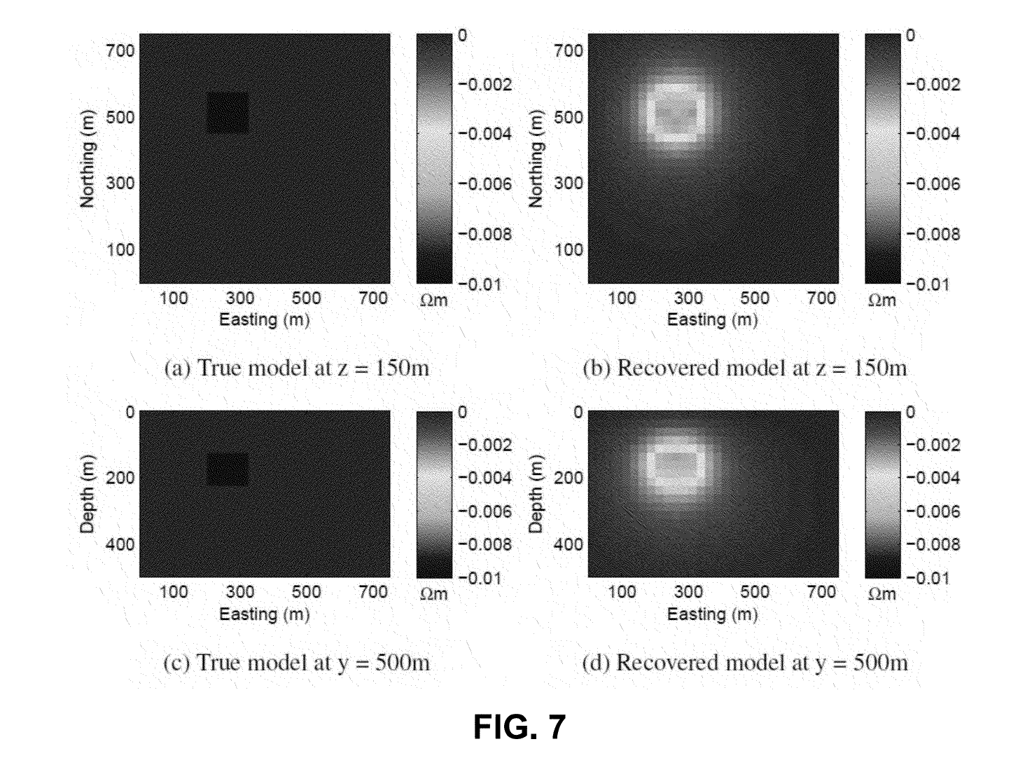

A plan view and cross-section of the true and recovered δρ_{Re} models are shown in FIG. 7. The depth and horizontal extents of the chargeable material are well located. As usual, with such inversions, there is some extension of the chargeability away from the boundaries of the true block and also the amplitude of the recovered chargeability is lower than the true value. This is a result of the smallness and smoothness terms used to regularize the inversion. Overall, the inversion has been successful in locating the chargeable material.

### Importance of Background Conductivity Model

Calculation of the sensitivities, which form a central role in the inversion of the ISIP data, use knowledge of the background resistivity. In the previous example, the real part of the true resistivity was used. In reality however, this quantity is not known, and an estimate of the resistivity structure is used. Depending on the method used to generate the estimate, the model may not be a good representation of the true resistivities in the area of interest.

In order to test the importance of the background resistivity model, two additional inversions were performed. In the first, a 200 Ωm half space is used to generate the sensitivities. In the second, the 1 Hz data were first inverted to recover a 3D resistivity model.

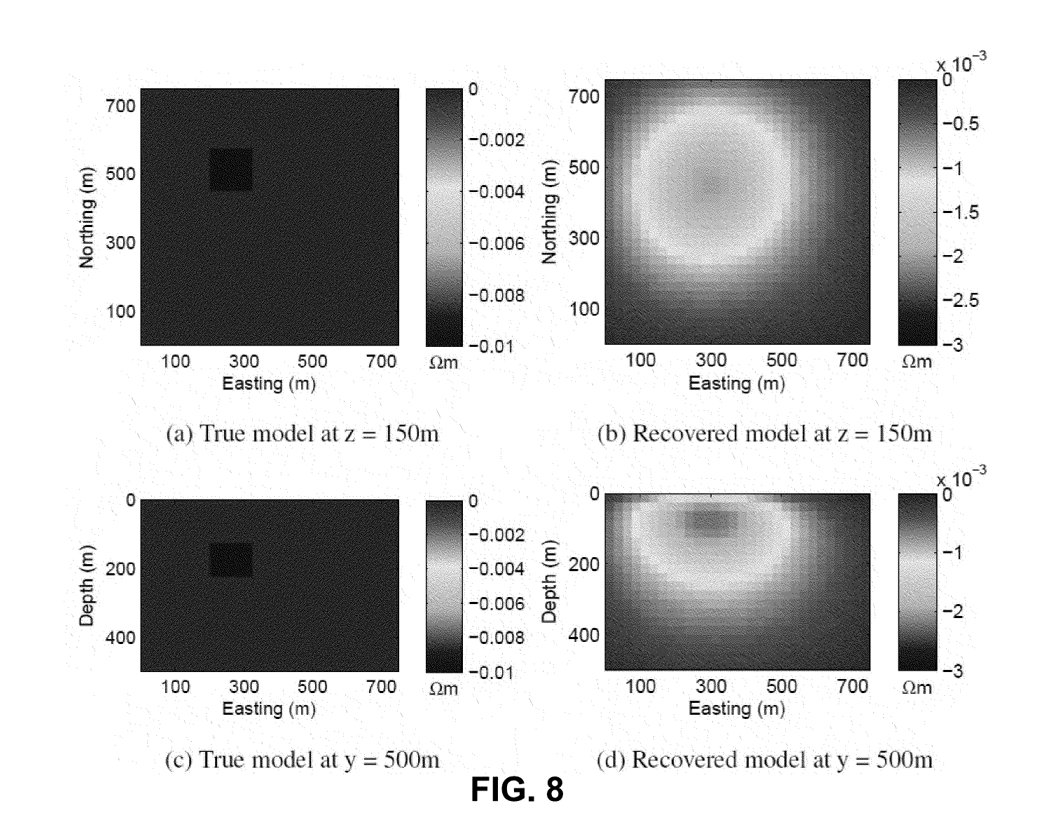

The resulting chargeability model obtained by using sensitivities from a 200 Ωm half space are shown in FIG. 8. A chargeable body is clearly recovered but the resolution is substantially reduced compared to that in FIG. 7. The body has moved toward the surface and it is also spread out in the horizontal direction. Nevertheless, the result provides useful information as its maximum value coincides horizontally with the centre of the true prism. This is a positive result and shows that knowledge of the background is important but not critical to getting some valuable information from the ISIP data. Moreover, the example given here (where the true resistivity in the model varies between 1 and 10000 Ωm, and it has been replaced by a uniform earth of 200 Ωm) is indicative of a very poor estimate of the resistivity.

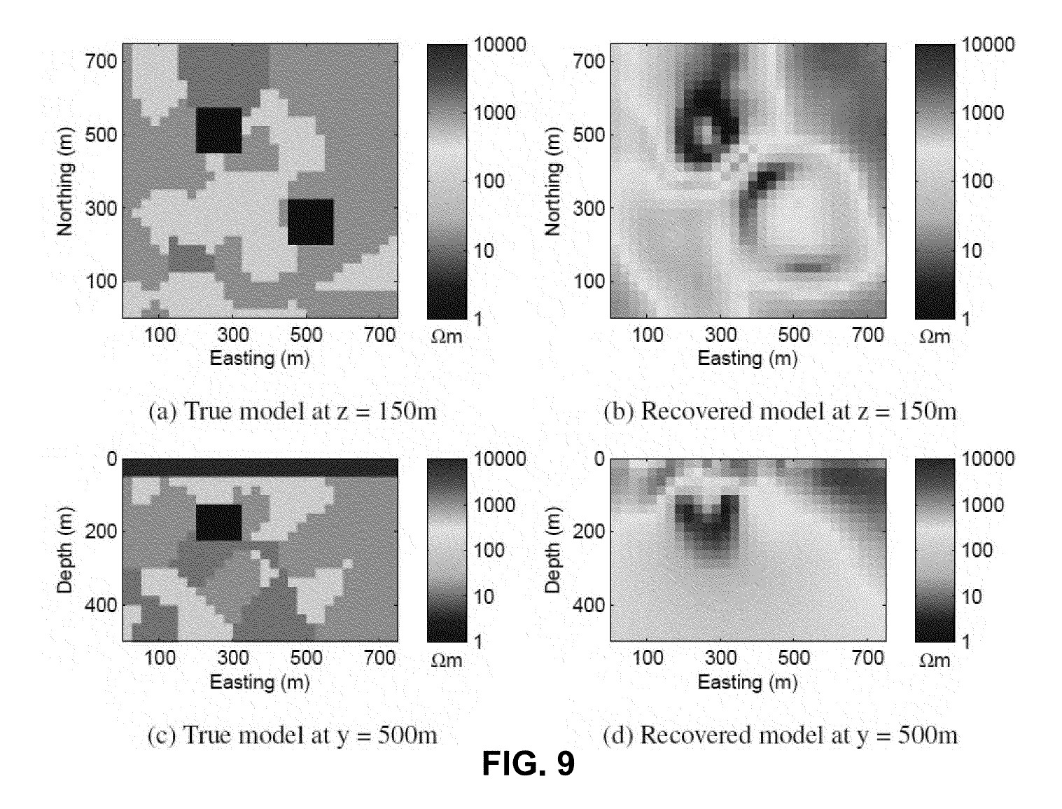

In the second example, the contaminated 1 Hz data were first inverted using the FEM inversion code EH3D, as described in Haber, E., Oldenburg, D., & Ascher, U. M., 2004. Inversion of 3d electromagnetic data in frequency and time domain using an inexact all-at-once approach, Geophysics, 69, 1216-1228, to recover a real 3D resistivity model. Plan view and cross-sections of the true and recovered resistivity model are shown in FIG. 9. As the inversion is working with only a single frequency, the resulting resistivity model differs substantially from the true model. Most of the major features can be recognized in the result, but they are highly distorted.

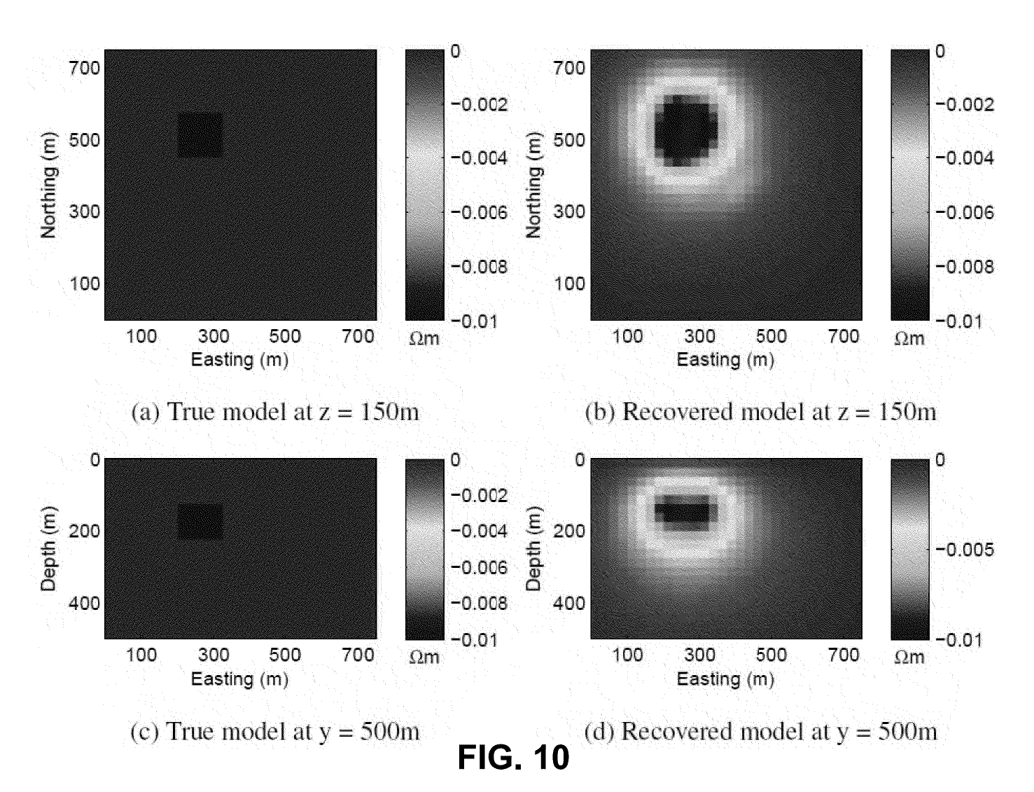

The inversion of the ISIP data using the recovered conductivities are shown in FIG. 10. The chargeable block is now well recovered and is nearly the same as that obtained from using the true conductivity. There is however a small artifact at (x, z)=(400,400), which appears to stem from additional structure in the recovered conductivity.

### ISIP Modification

In an alternative embodiment discussed below, the ISIP data may be modified so that it is practically usable across a wider range of frequencies than Equation 10.

The vertical magnetic fields measured by horizontal coplanar loops at the surface of a conductive halfspace is

$${H}_{z} = \frac{m}{2 π {k}^{2} {r}^{5}} [ 9 - ( 9 + 9 ikr - 4 {k}^{2} {r}^{2} - {ik}^{3} {r}^{3} ) {e}^{- i kr} ] \qquad ( 28.1 )$$

where m is the dipole moment of the transmitter loop, k is the wave number (k=(−iμσω)^{1/2}), and r is the distance between the transmitter and the receiver. The quantity β is defined to be

β=ikr=−(1+i)α (28.2)

where α is the induction number, as first introduced in Equation 13.5:

$$\begin{matrix}α = \frac{r}{δ} \\ = {r ( \frac{σμω}{2} )}^{1 / 2}\end{matrix} \qquad ( 28.3 )$$

Rewriting Equation 28.1 in terms of β gives

$${H}_{z} = \frac{m}{2 {πβ}^{2} {r}^{3}} [ ( 9 + 9 β + 4 {β}^{2} + {β}^{3} ) {e}^{- β} - 9 ) \qquad ( 28.4 )$$

The behavior of the function at low wavenumber can be approximated by expanding e^{-β} about β=0 and substituting the result into Equation 28.4. This gives

$${H}_{z} \approx - \frac{m}{4 π {r}^{3}} ( 1 + \frac{{β}^{2}}{4} - \frac{4 {β}^{3}}{15} + \frac{{β}^{4}}{8} - \frac{4 {β}^{5}}{105} + O ( {β}^{6} ) ) \qquad ( 28.5 )$$

If a non-dispersive conductivity is assumed, this expression is easily separated into real and imaginary parts with

$$\begin{matrix}Re [ {H}_{z} ] \approx - \frac{m}{4 π {r}^{3}} ( 1 - \frac{8 {α}^{3}}{15} - \frac{{α}^{4}}{2} - \frac{16 {α}^{5}}{105} + O ( {α}^{7} ) ) & ( 28.6 a ) \\ Im [ {H}_{z} ] \approx - \frac{m}{4 π {r}^{3}} ( \frac{{α}^{2}}{2} + \frac{8 {α}^{3}}{15} - \frac{16 {α}^{5}}{105} + O ( {α}^{6} ) ) & ( 28.6 b )\end{matrix}$$

Taking only the first term leaves

$$Im [ {H}_{z} ] \approx - \frac{m {α}^{2}}{8 π {r}^{3}} + O ( {α}^{3} ) \qquad ( 28.7 )$$

which depends linearly on ω. The ISIP assumption, as first stated in Equation 9 and as restated below as Equation 28.8, is valid as long as α³<<α².

$$\frac{Im [ {H}_{1} ]}{{ω}_{1}} - \frac{Im [ {H}_{2} ]}{{ω}_{2}} \approx 0 \qquad ( 28.8 )$$

The same result can also be obtained by considering the quantity Im[H_{z}]+Re[H_{z}] as the α³ terms in Equations 28.6a and 28.6b are of equal magnitude and opposite sign. This quantity simplifies to

$$Im [ {H}_{z} ] + Re [ {H}_{z} ] = - \frac{m}{4 π {r}^{3}} - \frac{m {α}^{2}}{8 π {r}^{3}} + O ( {α}^{4} ) = {H}_{0} - \frac{m {α}^{2}}{8 π {r}^{3}} + O ( {α}^{4} ) \qquad ( 28.9 )$$

Instead of Equation 28.8, Equation 28.10 can now be used:

$$\frac{Im [ {H}_{1} ] + Re [ {H}_{1} ]}{{ω}_{1}} - \frac{Im [ {H}_{2} ] + Re [ {H}_{2} ]}{{ω}_{2}} \approx 0 \qquad ( 28.10 )$$

According to an additional embodiment, the following is accordingly another definition for the ISIP data:

$${d}^{ISIP} = Im ( {H}^{s} ( {ω}_{2} ) ) + Re ( {H}^{s} ( {ω}_{2} ) ) - \frac{{ω}_{2}}{{ω}_{1}} [ Im ( {H}^{s} ( {ω}_{1} ) ) + Re ( {H}^{s} ( {ω}_{1} ) ) ] \qquad ( 28.11 )$$

As this only requires that α⁴<<α², this assumption remains valid over a wider range of frequencies than the definition of the ISIP data in Equation 9.

### Synthetic Example

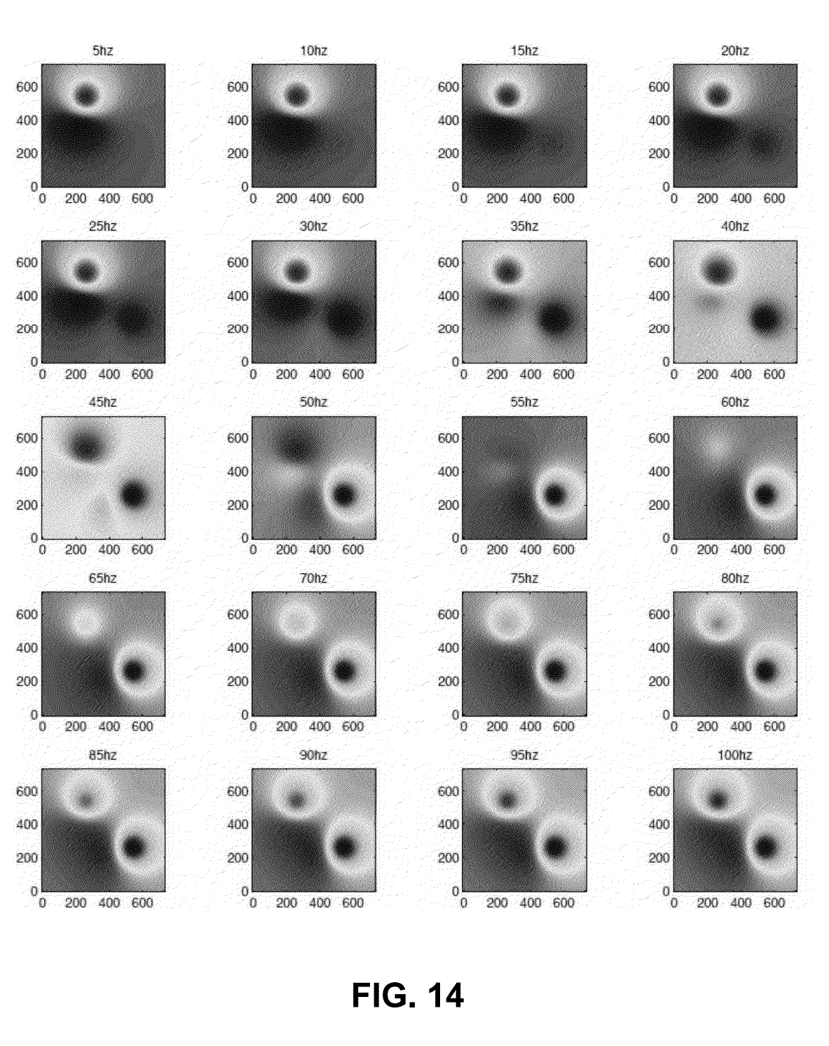

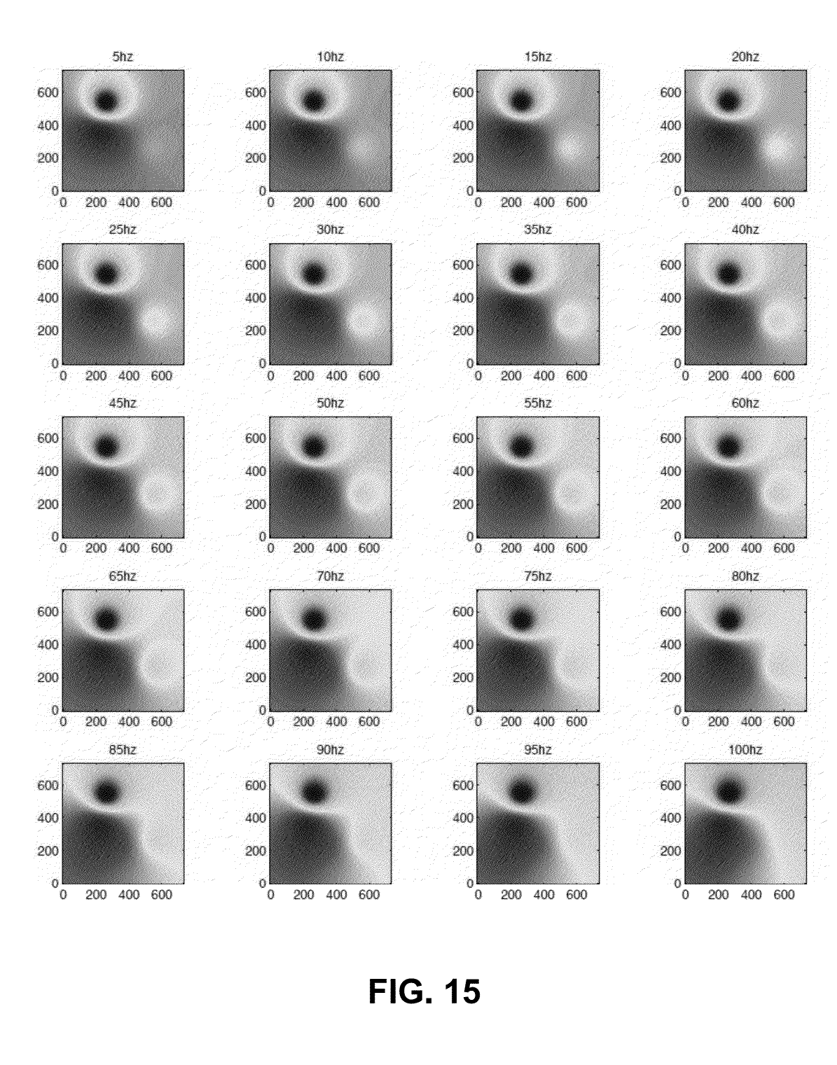

FIGS. 14 and 15 show the data calculated using Equations 28.8 and 28.10, respectively. The data are calculated from H_{z} from 200 m on a side transmitter located at (200,200). The background resistivity is 1000 Ohm-m. A chargeable block is buried at (300,500) that has a 10% dispersion and a DC resistivity of 1 Ohm-m. A second 1 Ohm-m, non-chargeable block is located at (500,300). ω₁ is shown on the figures. ω₂ is equal to 1.05ω₁. In FIG. 14, the ISIP data identifies the chargeable block as being chargeable from approximately 5 Hz to approximately 50 Hz. In contrast, in FIG. 15 the ISIP data identifies the chargeable block as being chargeable from approximately 5 Hz to approximately 100 Hz.

### Ground Based Measurements

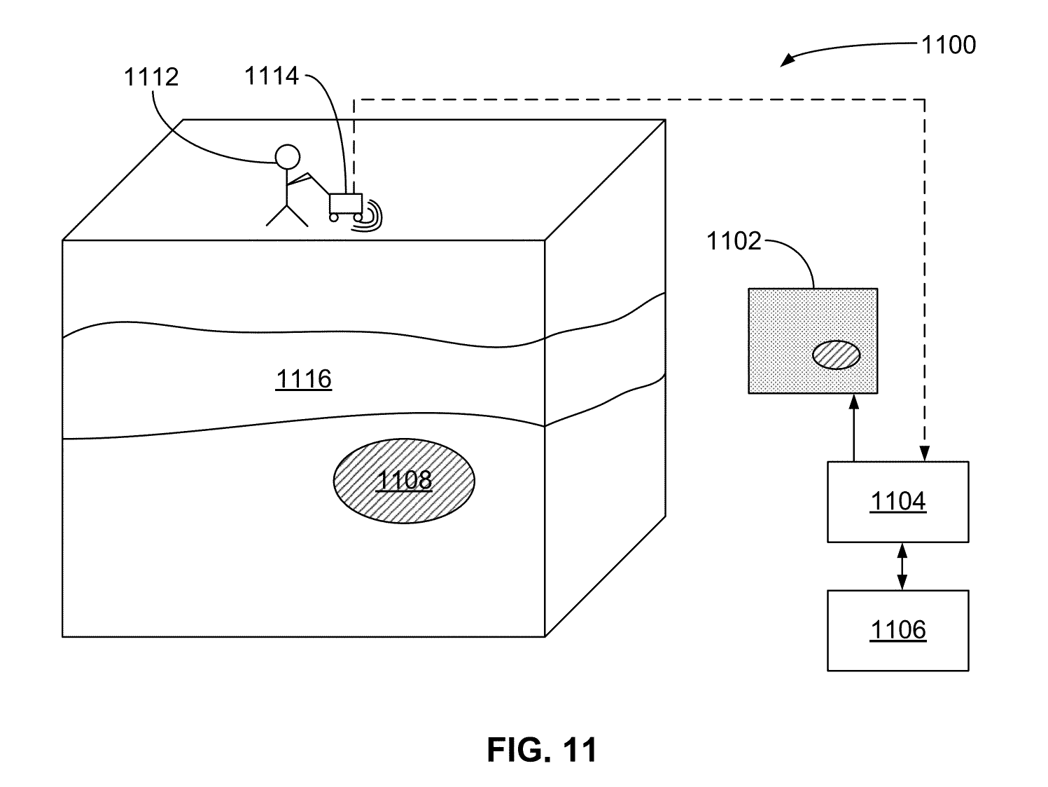

FIG. 11 displays a system 1100 for surveying distribution of chargeability in a volume of earth, according to one embodiment in which the primary and secondary magnetic fields are transmitted and received, respectively, using ground based equipment. Example ground based transmitters and receivers that may be used to perform the ground based survey include SQUID magnetometers from Supracon™ AG and low frequency field induction sensors from Schlumberger™ Limited (such as the BF-4 magnetic field induction sensor). The example methods described above can be performed and applied using the system 1100 of FIG. 11. More particularly, the ISIP data may be determined using computer equipment such as a processor in accordance with one or both of Equations 9 and 28.11, and based on the ISIP data it can be determined whether a volume of earth comprises chargeable material.

The volume of earth includes a geological target 1108 of relatively high chargeability and a resistive overburden 1116; an example of the geological target 1108 of relatively high chargeability is the chargeable block 102 of FIG. 1. A system operator 1112 operates a piece of ground based magnetic survey equipment 1114, which includes a magnetic transmitter and receiver (neither shown in FIG. 11). After completing a survey, the operator 1114 can download survey data to a processor 1104 that is communicatively coupled to a non-transitory computer readable medium 1106 that has encoded on it statements and instructions to perform any of the foregoing methods and, more particularly, to detect whether the chargeable material is present in the volume of earth based on the ISIP data determined using the secondary magnetic fields in accordance with one or both of Equations 9 and 28.11. A display 1102 is also communicatively coupled to the processor 1104, which allows the processor 1104 to display to the operator 1114 distributions of chargeability as depicted, for example, in FIGS. 2 and 4 through 6.

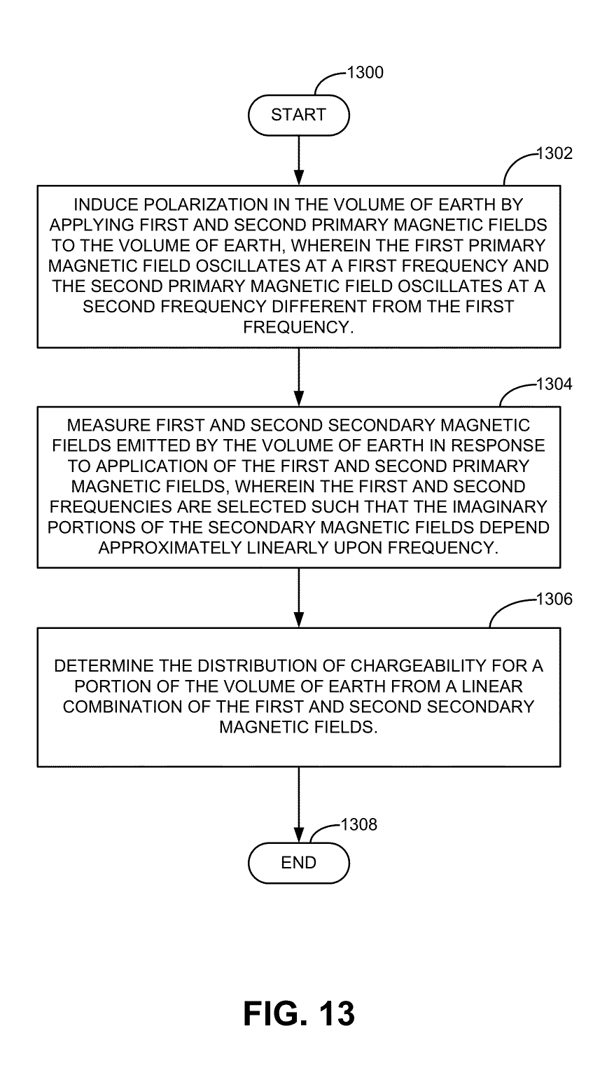

One method that may be encoded on to the medium 1106 is a method for surveying a distribution of chargeability in a volume of earth, as shown in FIG. 13. In FIG. 13, the processor 1104 begins performing the method at block 1300, and then proceeds to block 1302 at which it induces polarization in the volume of earth by applying first and second primary magnetic fields to the volume of earth, wherein the first primary magnetic field oscillates at a first frequency and the second primary magnetic field oscillates at a second frequency different from the first frequency. The processor 1104 energizes the magnetic transmitter in order to generate and apply the primary magnetic fields. The processor 1104 then proceeds to block 1304 at which it measures first and second secondary magnetic fields emitted by the volume of earth in response to application of the first and second primary magnetic fields, wherein the first and second frequencies are selected such that the imaginary portions of the secondary magnetic fields depend approximately linearly upon frequency as in the examples given above. The processor 1104 is communicative with the magnetic receiver, which generates an electric signal in response to exposure to the secondary magnetic fields that the processor 1104 analyzes. However, also as discussed, above, in an alternative embodiment (not depicted in FIG. 13), the first and second frequencies may be selected such that linearity, and consequently accuracy, are sacrificed in exchange for flexibility. The processor 1104 then proceeds to block 1306 where it determines the distribution of chargeability for a portion of the volume of earth from a linear combination of the first and second secondary magnetic fields. Determining the distribution of chargeability may be done, for example, by generating the graphs of d^{ISIP} as shown in FIG. 4 or by evaluating one or both of Equations 9 and 28.11. As discussed below, the method of FIG. 13 may be performed using ground based or air based transmitters and receivers.

### Air Based Measurements

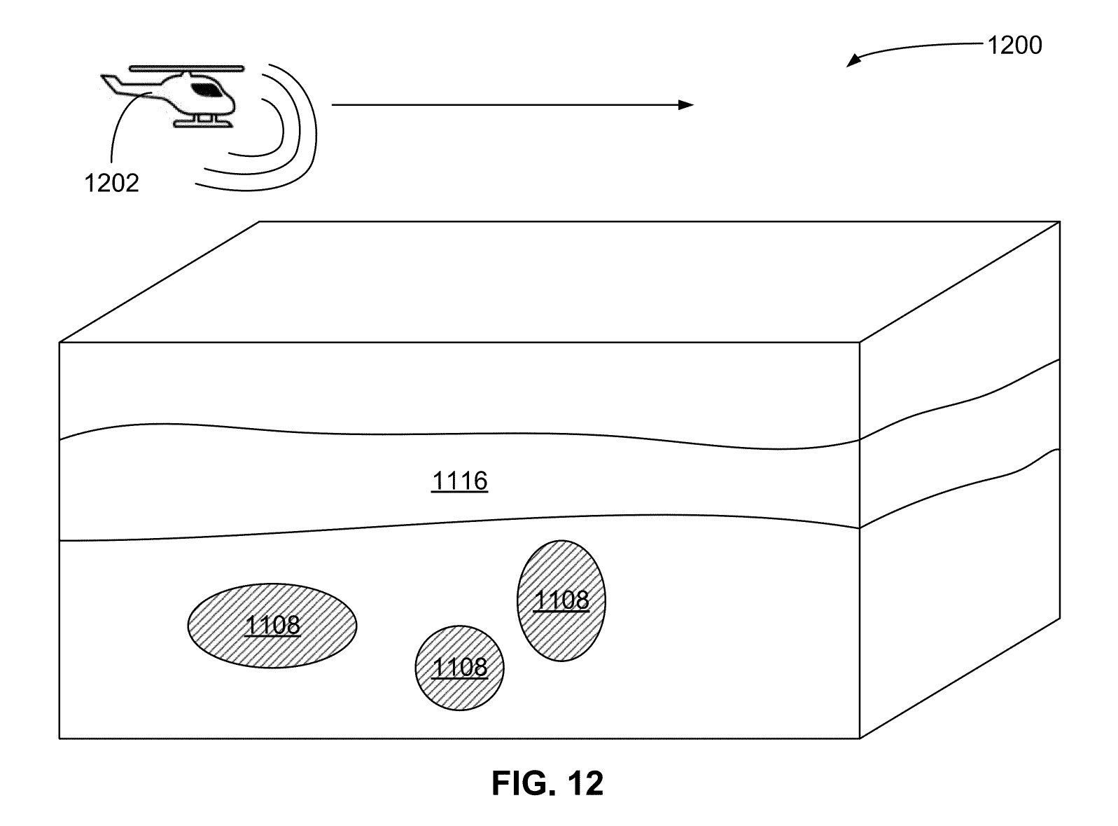

Referring now to FIG. 12, there is shown a system 1200 for surveying a distribution of chargeability in a volume of earth according to an embodiment in which the primary and secondary magnetic fields are transmitted and received, respectively, using air based equipment. As in FIG. 11, in FIG. 12 the volume of earth includes resistive overburden 1116 and various geological targets 1108 of relatively high chargeability relative to the remainder of the volume of earth. In contrast to the system 1100 of FIG. 11, the system 1200 of FIG. 12 surveys the volume of earth using an airborne transmitter and receiver, both of which are in a helicopter 1202. Example transmitters and receivers that may be used to perform the airborne survey may be based on equipment that includes the HELITEM™ system from Fugro™ Airborne Surveys and the VTEM™, VTEM™ Plus, and VTEM™ Max systems from Geotech™ Ltd. The method for performing the survey is otherwise substantially similar, with the following exceptions.

One, instead of determining the ISIP data using vector subtraction to determine the difference between the imaginary components of the measured secondary magnetic fields, the ISIP data may be determined using the magnitudes of the imaginary components of the fields in order to compensate for errors in aligning the transmitter and receiver that result from the method being performed via the air. Regardless of whether the secondary magnetic fields are measured simultaneously or at different times, the processor 1104 may use the following equation, based on Equation 9, to determine the ISIP data:

$${d}^{ISIP} = \vert Im ( {H}^{s} ( {ω}_{2} ) ) \vert - \frac{{ω}_{2}}{{ω}_{1}} \vert Im ( {H}^{s} ( {ω}_{1} ) ) \vert \qquad ( 29 )$$

Alternatively or additionally, the processor 1104 may analogously use the following equation, based on Equation 28.11, to determine the ISIP data:

$${d}^{ISIP} = \vert Im ( {H}^{s} ( {ω}_{2} ) ) + Re ( {H}^{s} ( {ω}_{2} ) ) \vert - \frac{{ω}_{2}}{{ω}_{1}} \vert Im ( {H}^{s} ( {ω}_{1} ) ) + Re ( {H}^{s} ( {ω}_{1} ) ) \vert \qquad ( 29.1 )$$

If the secondary magnetic fields are measured simultaneously, then the processor 1104 may alternatively use the following equation, based on Equation 9, to determine the ISIP data:

$${d}^{ISIP} = \vert Im ( {H}^{s} ( {ω}_{2} ) ) - \frac{{ω}_{2}}{{ω}_{1}} Im ( {H}^{s} ( {ω}_{1} ) ) \vert \qquad ( 30 )$$

Alternatively or additionally, the processor 1104 may analogously use the following equation, based on Equation 28.11, to determine the ISIP data:

$${d}^{ISIP} = \vert Im ( {H}^{s} ( {ω}_{2} ) ) + Re ( {H}^{s} ( {ω}_{2} ) ) - \frac{{ω}_{2}}{{ω}_{1}} [ Im ( {H}^{s} ( {ω}_{1} ) ) + Re ( {H}^{s} ( {ω}_{1} ) ) ] \vert \qquad ( 30.1 )$$

As in the embodiment of FIG. 11, the processor 1104 may then display a graph of the chargeability via the display 1102. To compensate for motion of the helicopter 1202 while measuring the secondary magnetic fields, the processor 1104 may deblur the graph by applying one or more motion deblurring methods, such as those described in Nayar, S. K. & Ben-Ezra, M., 2004. Motion-based motion deblurring, IEEE Transactions on Pattern Analysis and Machine Intelligence, 26(6), 689-698.

While the helicopter 1202 is used to perform the survey in FIG. 12, in alternative embodiments (not depicted), another aircraft, such as a fixed wing aircraft, may be used.

The foregoing describes embodiments of methods, systems, and techniques to invert for chargeability using inductive magnetic sources. Using the simple asymptotic behaviour of the fields at low frequencies new data, referred to as the ISIP data, is introduced. At low frequencies these data are identically zero if the conductivity is purely real. Thus any nonzero value of this datum is a direct indicator of chargeable material. Numerical simulations demonstrate that this is true even in a complex geological environment.

The foregoing also describes a linearized approximation that relates ISIP data to the chargeability. The link between these two quantities is the sensitivity matrix which is evaluated using the real, frequency independent, conductivity. In synthetic inversions it is shown that important information about the existence and location of the chargeable structure can be obtained even with a fairly poor knowledge about the conductivity and that the resolution increases as the quality of the conductivity model increases.

The embodiments above provide a methodology for detecting and mapping the presence of chargeable material without needing to inject current into the ground or place electrodes to measure potentials. By avoiding these requirements these embodiments may prove to be a useful tool in geologic settings where traditional IP difficult is difficult to perform.

The processor 1104 used in the foregoing embodiments may be, for example, a microprocessor, microcontroller, digital signal processor, programmable logic controller, field programmable gate array, or an application-specific integrated circuit. Examples of the computer readable medium 1106 are non-transitory and include disc-based media such as CD-ROMs and DVDs, magnetic media such as hard drives and other forms of magnetic disk storage, semiconductor based media such as flash media, random access memory, and read only memory.

It is contemplated that any part of any aspect or embodiment discussed in this specification can be implemented or combined with any part of any other aspect or embodiment discussed in this specification.

For the sake of convenience, the example embodiments above are described as various interconnected functional blocks. This is not necessary, however, and there may be cases where these functional blocks are equivalently aggregated into a single logic device, program or operation with unclear boundaries. In any event, the functional blocks can be implemented by themselves, or in combination with other pieces of hardware or software.

While particular embodiments have been described in the foregoing, it is to be understood that other embodiments are possible and are intended to be included herein. It will be clear to any person skilled in the art that modifications of and adjustments to the foregoing embodiments, not shown, are possible.

### REFERENCES

Amestoy, P. R., Guermouche, A., LaExcellent, J. Y., & Pralet, S., 2006. Hybrid scheduling for the parallel solution of linear systems, Parallel Computing, 32, 136-156.

Beard, D., & Zhou, Q., 1995. Method of skin effect correction and data quality verification for a multi-frequency induction well logging instrument, U.S. Pat. No. 5,666,057.

Chen, J. & Oldenburg, D. W., 2003. 3-d inversion of magnetic induced polarization data, in Three-dimensional electromagnetics III, p. 11p., eds Macnae, J. & Liu, G.

Cole, K. S. & Cole, R. H., 1941. Dispersion and absorption is dielectrics, Journal of Chemical Physics, 9, 341-351.

Davydycheva, S., Rykhlinski, N., & Legeido, P., 2006. Electrical-prospecting method for hydrocarbon search using the induced-polarization effect, Geophysics, 71, G179-G189.

Fink, J. B., McAlister, E. O., Sternberg, B. K., Wieduwilt, W. G., & Ward, S. H., 1990. Induced Polarization, Applications and Case Histories, vol. 4 of Investigations in Geophysics., Society of Exploration Geophysicists.

Fuller, B. & Ward, S. H., 1970. Linear System Description of the Electrical Parameters of Rocks, IEEE Transactions on Geoscience Electronics, 8(1), 7-18.

Gasperikova, E. & Morrison, H. F., 2001. Mapping of induced polarization using natural fields, Geophysics, 66, 137-147.

Haber, E. & Ascher, U. M., 2001. Fast finite volume simulation of 3d electromagnetic problems with highly discontinuous coefficients, SIAM Journal on Scientific Computing, 22, 1216-1228.

Haber, E., Oldenburg, D., & Ascher, U. M., 2004. Inversion of 3d electromagnetic data in frequency and time domain using an inexact all-at-once approach, Geophysics, 69, 1216-1228.

Hoheisel, A. Hördt, A., & Hanstein, T., 2004. The influence of induced polarization on long-offset transient electromagnetic data, Geophysical Prospecting, 52, 417-426.

Hohmann, G. W., Kintzinger, P. R., Van Voorhis, G. D., & Ward, S. H., 1970. Evaluation of the measurement of induced electrical polarization with an inductive system, Geophysics, 35, 901-915.

Hördt, A., Blasschek, R., & Kemna, A., 2007. Hydraulic conductivity estimation from induced polarisation data at the field scale—the Krauthausen case history, Journal of Applied Geophysics, 62, 33-46.

Kawai, J., Uehara, G., Kohrin, T., Ogata, H., & Kado, H., 1999. Three axis SQUID magnetometer for low-frequency geophysical applications, IEEE Transactions on Magnetics, 35, 3974-3976.

Kelley, C. T., 1999. Iterative methods for optimization, no. 18, SIAM Frontiers in Applied Mathematics.

Li, Y. & Oldenburg, D. W., 2000. 3-d inversion of induced polarization data, Geophysics, 65, 1931-1945.

Morrison, H. F., Phillips, R. J., & O'Brian, D. P., 1969. Quantitative interpretation of transient electromagnetic fields over a layered halfspace, Geophysical Prospecting, 17, 82-101.

Nayar, S. K. & Ben-Ezra, M., 2004. Motion-based motion deblurring, IEEE Transactions on Pattern Analysis and Machine Intelligence, 26(6), 689-698.

Oldenburg, D. W. & Li, Y., 2005. Inversion for applied geophysics: A tutorial. In: Near-Surface Geophysics, SEG Investigations in Geophysics Series No. 13, (ed. D. K. Butler), pp. 89-150. SEG

Oldenburg, D. W. & Li, Y., 1994. Inversion of induced polarization data, Geophysics, 59, 1327-1341.

Pelton, W. H., Ward, S. H., Hallof, P. G., Sill, W. R., & Nelson, P. H., 1978. Mineral discrimination and removal of inductive inductive coupling with multifrequency IP, Geophysics, 43, 588-609.

Seigel, H. O., 1959. Mathematical formulation and type curves for induced polarization, Geophysics, 24(3), 547-565.

Seigel, H. O., 1974. The magnetic induced polarization (MIP) method, Geophysics, 39, 321-339.

Seigel, H. O., Nabighian, M., Parasnis, D. S., & Vozoff, K., 2007. The early history of the induced polarization method, The Leading Edge, 26, 312-321.

Slater, L. D. & Glaser, D. R., 2003. Controls on induced polarization in sandy unconsolidated sediments and application to aquifer characterization, Geophysics, 68, 1547-1558.

Smith, R. S. & West, G. F., 1988. Inductive interaction between polarizable conductors: An explanation of a negative coincident-loop transient electromagnetic response, Geophysics, 53, 677-690.

Veeken, P. C. H., Kudryavceva, E. O., Putikov, O. F., Legeydo, P. Y., & Ivanov, S. A., 2012. Modelling induced polarization effects due to pyrite in geochemical alteration zones above hydrocarbon accumulations, Petroleum Geoscience, 18, 59-72.

Wang, T., Yu, L., & Fanini, O., 2003. Multicomponent induction response in a borehole environment, Geophysics, 68, 1510-1518.

Weidelt, P., 1982. Response characteristics of coincident loop transient electromagnetic systems, Geophysics, 47, 1325-1330.

Wong, J., 1979. An electrochemical model of the induced-polarization phenomenon in disseminated sulfide ores, Geophysics, 44, 1245-1265

Yee, K. S., 1966. Numerical solution of initial boundary value problems involving maxwell's equations in isotropic media, IEEE Trans. on antennas and propagation, 14, 302-307.

All of the foregoing references are hereby incorporated by reference herein.

1. A method for surveying a distribution of chargeability in a volume of earth, the method comprising:
(a) inducing polarization in the volume of earth by applying first and second primary magnetic fields to the volume of earth, wherein the first primary magnetic field oscillates at a first frequency and the second primary magnetic field oscillates at a second frequency different from the first frequency;
(b) measuring first and second secondary magnetic fields emitted by the volume of earth in response to application of the first and second primary magnetic fields, wherein the first and second frequencies are selected such that an induction number for the volume of earth is less than unity; and
(c) determining the distribution of chargeability for the volume of earth from a linear combination of imaginary components of the first and second secondary magnetic fields.

2. The method of claim 1 wherein the first and second frequencies are selected such that imaginary portions of the secondary magnetic fields depend approximately linearly upon frequency.

3. The method of claim 1 wherein the linear combination comprises a scaled linear combination of the imaginary components of the secondary magnetic fields.

4. The method of claim 1 wherein the linear combination comprises a scaled linear combination of the real and imaginary components of the secondary magnetic fields.

5. The method of claim 1 wherein the linear combination comprises an absolute value of a scaled linear combination of the imaginary components of the secondary magnetic fields.

6. The method of claim 1 wherein the linear combination further comprises an absolute value of a scaled linear combination of the real and imaginary components of the secondary magnetic fields.

7. The method of claim 1 wherein the linear combination comprises a scaled linear combination of absolute values of the imaginary components of the secondary magnetic fields.

8. The method of claim 1 wherein the linear combination comprises a scaled linear combination of absolute values of the real and imaginary components of the secondary magnetic fields.

9. The method of claim 1 wherein the primary magnetic fields are applied from a ground based transmitter, the secondary magnetic fields are measured from a ground based receiver, and the linear combination comprises
$$Im ( {H}^{s} ( {ω}_{2} ) ) - \frac{{ω}_{2}}{{ω}_{1}} Im ( {H}^{s} ( {ω}_{1} ) ) ,$$
wherein ω₁ is the first frequency, ω₂ is the second frequency, H^{s}(ω₁) is the first secondary magnetic field, and H^{s}(ω₂) is the second secondary magnetic field.

10. The method of claim 1 wherein the primary magnetic fields are applied from a ground based transmitter, the secondary magnetic fields are measured from a ground based receiver, and the linear combination comprises
$$Im ( {H}^{s} ( {ω}_{2} ) ) + Re ( {H}^{s} ( {ω}_{2} ) ) - \frac{{ω}_{2}}{{ω}_{1}} [ Im ( {H}^{s} ( {ω}_{1} ) ) + Re ( {H}^{s} ( {ω}_{1} ) ) ] ,$$
wherein ω₁ is the first frequency, ω₂ is the second frequency, H^{s}(ω₁) is the first secondary magnetic field, and H^{s}(ω₂) is the second secondary magnetic field.

11. The method of claim 1 wherein the primary magnetic fields are applied from an air based transmitter, the secondary magnetic fields are simultaneously measured using an air based receiver, and the linear combination comprises
$$\vert Im ( {H}^{s} ( {ω}_{2} ) ) - \frac{{ω}_{2}}{{ω}_{1}} Im ( {H}^{s} ( {ω}_{1} ) ) \vert ,$$
wherein ω₁ is the first frequency, ω₂ is the second frequency, H^{s}(ω₁) is the first secondary magnetic field, and H^{s}(ω₂) is the second secondary magnetic field.

12. The method of claim 1 wherein the primary magnetic fields are applied from an air based transmitter, the secondary magnetic fields are measured using an air based receiver, and the linear combination comprises
$$\vert Im ( {H}^{s} ( {ω}_{2} ) ) \vert - \frac{{ω}_{2}}{{ω}_{1}} \vert Im ( {H}^{s} ( {ω}_{1} ) ) \vert ,$$
wherein ω₁ is the first frequency, ω₂ is the second frequency, H^{s}(ω₁) is the first secondary magnetic field, and H^{s}(ω₂) is the second secondary magnetic field.

13. The method of claim 1 wherein the primary magnetic fields are applied from an air based transmitter, the secondary magnetic fields are measured using an air based receiver, and the linear combination comprises
$$\vert Im ( {H}^{s} ( {ω}_{2} ) ) + Re ( {H}^{s} ( {ω}_{2} ) ) \vert - \frac{{ω}_{2}}{{ω}_{1}} \vert Im ( {H}^{s} ( {ω}_{1} ) ) + Re ( {H}^{s} ( {ω}_{1} ) ) \vert ,$$
wherein ω₁ is the first frequency, ω₂ is the second frequency, H^{s}(ω₁) is the first secondary magnetic field, and H^{s}(ω₂) is the second secondary magnetic field.

14. The method of claim 1 wherein the primary magnetic fields are applied from an air based transmitter, the secondary magnetic fields are simultaneously measured using an air based receiver, and the linear combination comprises
$$\vert Im ( {H}^{s} ( {ω}_{2} ) ) + Re ( {H}^{s} ( {ω}_{2} ) ) - \frac{{ω}_{2}}{{ω}_{1}} [ Im ( {H}^{s} ( {ω}_{1} ) ) + Re ( {H}^{s} ( {ω}_{1} ) ) ] \vert ,$$
wherein ω₁ is the first frequency, ω₂ is the second frequency, H^{s}(ω₁) is the first secondary magnetic field, and H^{s}(ω₂) is the second secondary magnetic field.

15. The method of claim 12 wherein the secondary magnetic fields are measured at different times.

16. The method of claim 1 wherein the primary frequencies are selected such that a depth of the volume of earth to be surveyed is within two skin depths of the higher of the primary frequencies.

17. The method of claim 1 wherein the primary frequencies are selected such that a depth of the volume of earth to be surveyed is within one skin depth of the higher of the primary frequencies.

18. The method of claim 1 wherein the primary frequencies are within 5% of each other.

19. The method of claim 1 wherein the primary frequencies are 1 Hz and 2 Hz.

20. The method of claim 1 wherein the higher of the primary frequencies is less than or equal to approximately 45 Hz.

21. The method of claim 20 wherein the higher of the primary frequencies is less than or equal to 25 Hz.

22. The method of claim 1 further comprising displaying a graph of the distribution of chargeability.

23. The method of claim 22 further comprising compensating for motion while measuring the secondary magnetic fields by deblurring the graph.

24. A method for surveying a distribution of chargeability in a volume of earth, the method comprising:
(a) inducing polarization in the volume of earth by applying first and second primary magnetic fields to the volume of earth, wherein the first primary magnetic field oscillates at a first frequency and the second primary magnetic field oscillates at a second frequency different from the first frequency;
(b) measuring first and second secondary magnetic fields emitted by the volume of earth in response to application of the first and second primary magnetic fields, wherein the first and second frequencies are selected such that actual values of imaginary portions of the secondary magnetic fields are within 20% of values of the imaginary portions determined assuming the imaginary portions depend linearly upon frequency; and
(c) determining the distribution of chargeability for the volume of earth from a linear combination of the first and second secondary magnetic fields.

25. A system for surveying distribution of chargeability in a volume of earth, the system comprising:
(a) a magnetic transmitter configured to generate a first primary magnetic field oscillating at a first frequency and a second primary magnetic field oscillating at a second frequency different from the first frequency;
(b) a magnetic receiver configured to measure first and second secondary magnetic fields emitted by the volume of earth in response to application of the first and second primary magnetic fields, wherein the first and second frequencies are selected such that an induction number for the volume of earth is less than unity;
(c) a processor; and
(d) a memory having encoded thereon statements and instructions to cause the processor to determine the distribution of chargeability for the volume of earth from a linear combination of imaginary components of the first and second secondary magnetic fields.

26. A non-transitory computer readable medium having encoded thereon statements and instructions to cause a processor to determine a distribution of chargeability for a volume of earth from a linear combination of imaginary components of first and second secondary magnetic fields generated by applying first and second primary magnetic fields to the volume of earth, wherein the first primary magnetic field oscillates at a first frequency and the second primary magnetic field oscillates at a second frequency different from the first frequency, and wherein the first and second frequencies are selected such that an induction number for the volume of earth is less than unity.
